(19) United States
(12) Patent Application Publication
(10) Pub. No.: US 2007/0124213 A1
(43) Pub. Date: May 31, 2007

(54) Systems and methods for automatically assigning an incoming quantity of goods in response to an event

(76) Inventors: Andreas Esau, Oestringen (DE); Hans-Ulrich Von Helmolt, Heidelberg (DE); Gerhard Hirth, Dielheim (DE); Thomas Mayer, Leimen (DE)

Correspondence Address: SAP / FINNEGAN, HENDERSON LLP, 901 NEW YORK AVENUE, NW, WASHINGTON, DC, 20001-4413, US

(21) Appl. No.: 11/594,783

(22) Filed: Nov. 9, 2006

(30) Foreign Application Priority Data
Nov. 10, 2005 (EP) 05077565.9

(51) Int. Cl. G06Q 30/00

(52) U.S. Cl. 705/26

(57) ABSTRACT

Systems and methods are provided for automatically assigning an incoming quantity of goods in response to an event. In one implementation, a system is provided for automatically assigning an incoming quantity of goods in response to an event. The system comprises an inbound interface for interfacing with a plurality of data storage devices in at least one of which the incoming quantity of goods are stored as data and a plurality of sales orders to be confirmed are stored; an execution memory operable to hold a software system, and a processor for coupling to the inbound interface and the execution memory, the processor being operable to execute the software system such that the software system operates to select a subset of sales orders from the plurality of sales to be confirmed according to one or more predetermined criteria and to assign to the subset of sales orders the incoming quantity of goods.

### TECHNICAL FIELD

The present invention generally relates the field of data processing and to computerized systems and methods for automatically assigning an incoming quantity of goods in response to an event. More particularly, and without limitation, the invention relates to systems and methods for using a predetermined criteria to assign an incoming quantity of goods to a subset of sales orders.

### BACKGROUND INFORMATION

Supply chain management software systems, such SAP's Supply Chain Management (SAP SCM) system, currently exist in the industry. Such supply chain management systems may include a plurality of applications for implementing the management of the supply chain. SAP's Advanced Planning and Optimization (SAP APO) and Extended Warehouse Management (EWM) are examples of these applications. A core interface (CIF) may connect SAP SCM with online transaction processing systems (OLTP), such as SAP Customer Relations Management (SAP CRM) and Enterprise Resource Planning (ERP). Also, the core interface may connect the OLTP to the SAP APO. In supply chain management, when a product is available to be promised to a customer, it is “available to promise” (ATP). Supply chain management systems including available to promise (ATP) functionality currently exist in the industry. Supply Chain Management applications, such as SAP APO may include ATP functionality. Such systems include software for determining whether a product is available to promise. This determination may include performing an availability check when a customer calls to place an order.

In conventional supply chain management systems like SAP SCM, events that may improve the availability situation of a given material cannot be evaluated to trigger functions or processes in order to optimize business opportunities. Such events include, for example, changes in stock, new planned supply or drop of demand. Triggered functions may include distribution of any additional surplus close in time to the occurring event. In conventional systems, a realignment of the availability situation, in response to an event, is only possible by mass availability check runs initiated at predefined points in time, for example, manually or periodically scheduled as a background job. The resulting time delay with respect to the monitoring effort leads to significant business impact since supply which would be available is not assigned directly to highly prioritized demands or demands that were put in at an earlier time. Thus, the business performance is compromised.

It is desirable to address one-or more problems, such as the problems identified above, in conventional systems. In particular, it is desirable to improve the business performance aspects of the application availability check to ensure that available stock-can be assigned to sales orders more quickly. Thus, it is further desirable to increase the speed with which aspects of the availability check can be carried out.

### SUMMARY

In view of the foregoing, systems and methods are disclosed herein for overcoming one or more of the above-mentioned problems. In accordance with embodiments of the invention, systems and methods may be provided for automatically assigning an incoming quantity of goods in response to an event. More specifically, embodiments of the invention include systems and methods for using a predetermined criteria to assign an incoming quantity of goods to a subset of sales orders.

In accordance with an embodiment of the invention, a system is provided for automatically assigning an incoming quantity of goods in response to an event. The system comprises an inbound interface for interfacing with a plurality of data storage devices in at least one of which the incoming quantity of goods are stored as data and a plurality of sales orders to be confirmed are stored; an execution memory operable to hold a software system, and a processor for coupling to the inbound interface and the execution memory, the processor being operable to execute the software system such that the software system operates: to select a subset of sales orders from the plurality of sales to be confirmed according to one or more predetermined criteria and to assign to the subset of sales orders the incoming quantity of goods.

In conventional systems, a realignment of the availability situation after changes in stock, planned supply, or demand change is only possible by mass availability check runs initiated at predetermined points in time, for example, after supply planning. In accordance with an aspect of the present invention, using event driven quantity assignment, it is possible to assign in real time, document changes as events which immediately trigger the fulfilment of certain demands, for example, high priority sales orders, and /or trigger deployment processes.

According to another embodiment of the present invention, a method is provided for automatically assigning an incoming quantity of goods in response to an event. The method comprises the steps of interfacing with a plurality of data storage devices in at least one of which the incoming quantity of goods are stored as data and a plurality of sales orders to be confirmed are stored, holding a software system in an executable memory, and coupling the inbound interface to the execution memory, executing the software system such that the software system operates to select a subset of sales orders from the plurality of sales to be confirmed according to one or more predetermined criteria and to assign to the subset of sales orders the incoming quantity of goods.

According to an embodiment of the present invention, a user terminal may be provided that includes means operable with systems and methods consistent with the invention, such as those previously described.

Embodiments of the present invention further relate to a computer readable storage medium that stores a program which, when run on a computer, controls the computer to perform systems and methods consistent with the present invention, such as those previously described.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is diagram of an exemplary backorder processing (BOP) system, consistent with an embodiment of the present invention;

FIG. 2 is a flow chart of an exemplary event driven quantity assignment method, consistent with an embodiment of the present invention;

FIG. 3 is a diagram of an exemplary system for carrying out an availability check, consistent with an embodiment of the present invention;

FIG. 4 is a diagram of an example of an activated ODL, consistent with an embodiment of the present invention;

FIG. 5 is a screen shot showing an example of how the selection via a chain may be made visible in the system, consistent with an embodiment of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

As previously described, SAP CRM and ERP are both examples of an OLTP system. SAP CRM or ERP may be used for daily online transaction processing, where sales orders may be entered. SAP APO is a logistic planning system that may be a component of SAP SCM. ATP may also be a component of SAP APO. A core interface CIF may connect the OLTP to the SAP APO and may provide functions to transfer the business data between the two types of systems. The ATP component may execute an availability check when a customer enquires about placing an order. To determine whether the product is available to promise, the availability check may take into account existing stock as well as the quantities of future incoming or outgoing orders that should be delivered by the date of the order. In illustrating a possible benefit, consider the following example. If a quantity (of stock or an incoming order) is promised to a first customer, a second customer may not be able to access their reserved quantity. If there is not enough quantity to honor a complete order as requested by the second customer, the order can either be confirmed at a later date, stay unconfirmed, or may be partially confirmed. However, if the product is available to promise, the order can be confirmed. Rules based availability (RBA) checks can be used to automatically or manually optimize the decision making process between alternative product items using predefined rules. In a sales order, RBA can cause the creation of a main item with several sub-items reflecting alternatives on a product/location level. For example, if a customer orders a yellow car, the rule may specify that he may be given a red car instead. Similarly, if the order cannot be confirmed from stock in a first manufacturing location, the rule may specify that the order is honored from stock in a second manufacturing location. In this way, global ATP may be provided to allow a switch between locations. Further, in a situation where there are several orders which cannot all be confirmed, those order which cannot be confirmed may become back orders. Back orders are sales documents whose order items cannot be completely confirmed as requested due to lack of availability or material shortages. Orders, including back orders, also may be assigned a priority rating such as a high priority order and a low priority order. If a high priority order cannot be confirmed immediately, it may become a back order. Back order processing (BOP) is a technical vehicle for dealing with back orders. BOP may be a tool of the ATP component, for example in SAP APO. Using BOP, an available quantity of one or more products may be reallocated using a quantity of selected requirements. BOP may be carried out as interactive BOP or batch BOP.

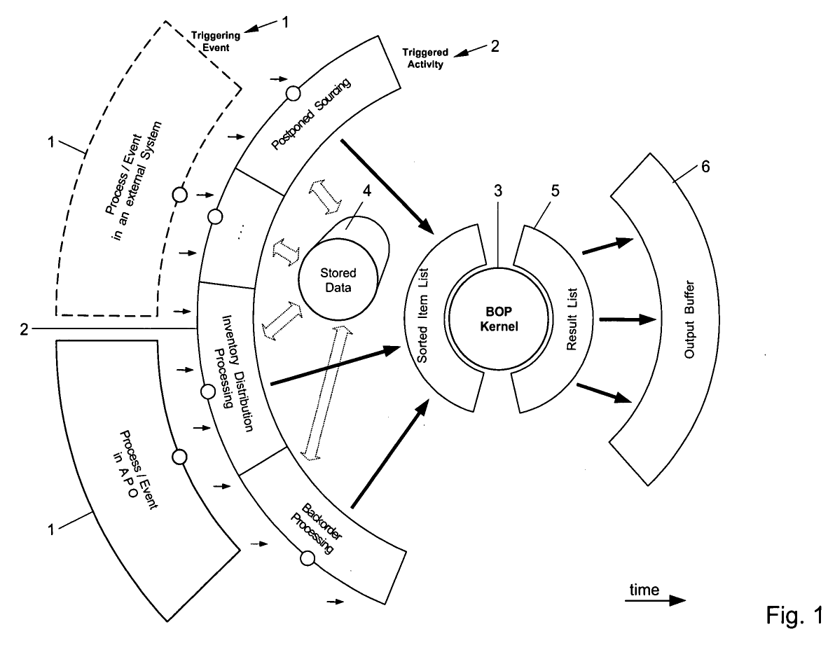

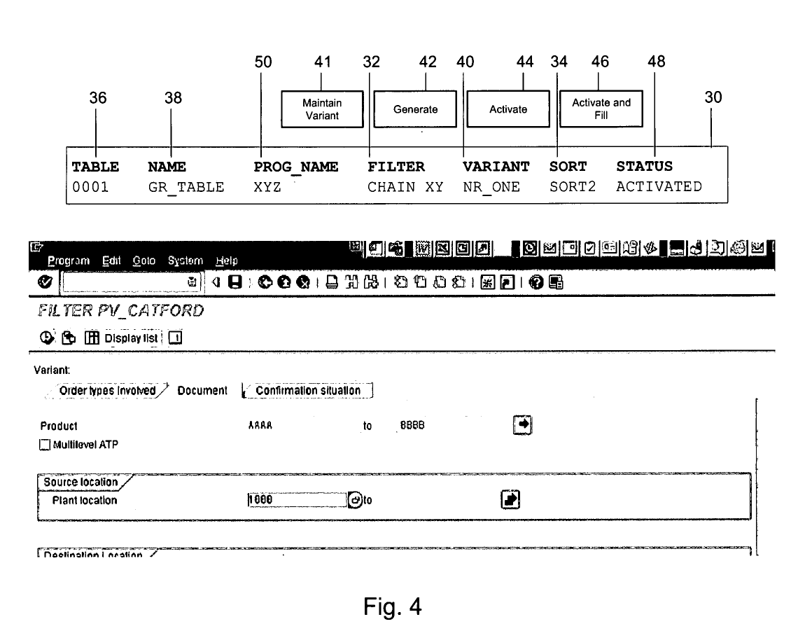

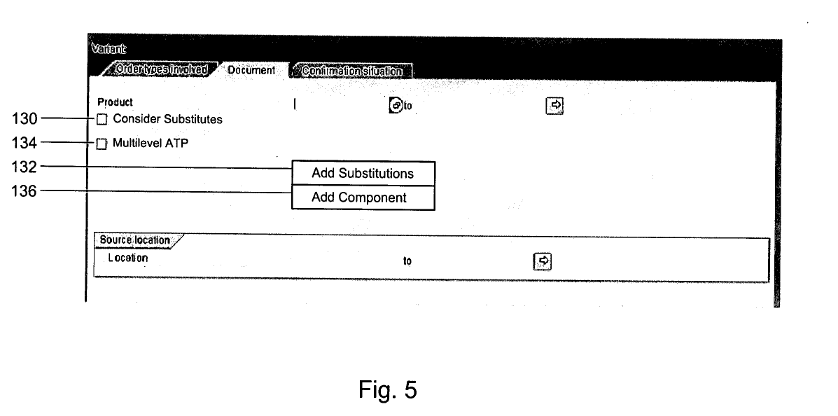

Thus, a situation may arise where there may be a plurality of backorders and an event (such as incoming goods or a cancelled order) may occur such that an incoming quantity may become available. In accordance with an embodiment of the current invention, the event may trigger a redistribution of the incoming quantity. This may be achieved using event driven quantity assignment services, wherein one or more activities, for example, changes in stock, are defined with respect to an event, as shown and described with respect to the example of FIG. 1. Further, an order due list (ODL), described in further detail with respect to the exemplary embodiments of FIGS. 4-5, may be assigned to the event. In particular, the order due lists may restrict the number of orders that are looked into when identifying the affected items. Depending on the parameter values that are valid in the particular inbound interface, different ODLs can be used. The potential amount of items that are to be confirmed can be kept small by customizing the ODL. In this way, the speed of the assignment is improved. Further by customizing the ODL, for example, to identify high priority backorders, the incoming goods can be assigned to those orders having the highest business priority.

In particular, according to embodiments of the invention, event driven global available to promise services in a supply chain management system, for example, SAP SCM, may be exploited by offering techniques to release quantities to prioritized order requirements. Positive changes of ATP quantity may be registered in corresponding SAP SCM inbound interfaces. Inbound interfaces may include interfaces for stock changes, interfaces for purchase orders, and interfaces for sales orders. Using event driven global available to promise services in SAP SCM, it is possible to assign now individually defined document changes communicated to SAP SCM from an external OLTP as events which may immediately trigger the fulfillment of highly prioritized demands and/or the deployment process (e.g., for spare parts planning). Depending on the activities, for example, changes in stock data, changes in purchase order documents, changes in sales documents and back order processing, and the individually definable selection criteria, according to an embodiment of the invention, the quantity may be distributed according to the range of selected order items that have to be confirmed and their sort sequence. The order due lists deliver the information for selection and sort. If all waiting order items (backorders) are confirmed, the still available quantity may be deployed to other facilities.

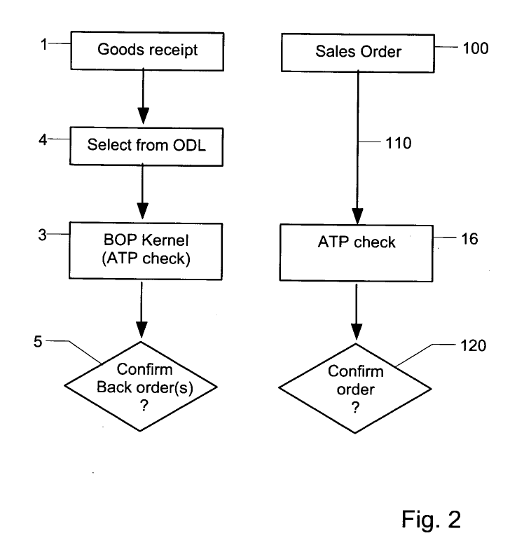

Event driven global available to promise, in accordance with an embodiment of the invention, can provide a trigger via the workflow event “Quantity release to order due lists”. The confirmation process may be based on the standard mass availability check (backorder processing), but may instead use order due lists to reduce the number of selected items and accelerate the process. A parameter set finally determines if and how event driven quantity assignment will be executed. The quantity that is being distributed can also be protected by changing its category, which makes it invisible to the standard ATP check, as described and shown in FIG. 2.

FIG. 1 shows an exemplary backorder processing (BOP) system and its triggering events within which an embodiment of the invention has application. As shown in FIG. 1, there may be a flexible assignment of pre-defined events and triggering modules to start workflows that are related to back order processing (BOP). An EDQA Agent 2 (a BOP related tool) may handle this assignment. The EDQA agent may use ODLs as input for confirmation of back ordered items after being triggered by an event, for example, by a goods receipt. EDQA may use a processor, in particular, BOP kernel 3 (a BOP based process step) and its output mechanism during the workflow. For example, in FIG. 1, the triggering event 1 may be a process/event in an external system, for example, a goods receipt. Once the goods are received, EDQA may be triggered as the triggered activity 2. The EDQA agent 2 may read the stored data in the data storage system 4 (in this case ODL). Subsequently, the BOP kernel 3 may carry out the BOP. In order to determine which items are affected, order due lists may be used to select the affected items. In this way, the speed of the backorder processing is increased. Further, the ODL may be customized in order to determine which items are selected, for example, on the basis of a priority rating. In this way, those items having the most business importance may be confirmed. Order due lists are described in further detail with reference to the exemplary embodiments of FIGS. 4 and 5. BOP is carried out when necessary, and may be carried out as a batch. The result list 5 of the BOP may be provided to an output buffer 6, which is the SAP APO storage system. The result list in the output buffer may be subsequently sent to the OLTP system.

In the case where the invention can be applied in back order processing, a processor, such as a back order kernel 3, carries out the back order processing which may include carrying out an availability check including RBA. At first the process may decide which items of the back order are to be checked and in what sequence. In order to do this a filter may be defined. The filter may have a filter type which defines what criteria are used to select the items to be processed. Criteria are, for example, customer type, product/location, item type (for example, sales order). The filter also may have a filter variant which defines which values of defined criteria meet the conditions of the filter. The order items may be stored in the OLTP system. They may also be stored in SAP APO. The filtering may select items corresponding to the particular filter to the particular data base. For example, the filter type may define a parameter—customer type. The filter variant may define the parameter value—customer type—very important or medium. In this way, the filter may be defined. This filter may select only items having a very important and medium important customer. In one embodiment, the filter can be designed to define back orders.

In another embodiment, event driven quantity assignment (EDQA) back order processing including global ATP may be used as an internal tool. If several orders cannot be confirmed and a quantity is received that the system can assign, back order processing may begin. For example, if a sales order is cancelled, the released quantity can be reassigned. Such a quantity assignment is called EDQA. In addition, for an event to be the cancellation of an order, it may include incoming stock and a changed order.

EDQA and ROC use order due lists (ODL) which are described in more detail below. Order due lists may use a filter to select orders. The ODL filtering may be used if the order is saved. At the time that the order item is saved, all filters of order due lists may be scanned. If an ODL is activated, it is being filled by the system via inbound interface with corresponding OLTP documents.

In addition to those drawbacks mentioned above, in conventional back order processing systems, the system typically has to search for back ordered items. To do this, conventional systems filter the whole database to find the affected items. Consistent with an aspect of the present invention, ODLs may provide an index function, and may allow affected items to be stored immediately after being saved. In this way, affected items can be retrieved faster than in conventional systems.

The ODL may be an additional data base element with a restricted number of fields, which may perform the function of an index. It may be assigned to a process, for example, EDQA, and may perform a pre-selection. The function performed may be that of a sorter. The ODL pre-selection can be edited manually. The pre-selection may be at least one of edited, deleted or overruled. The ODLs can be used as a reference for searching items under consideration of its priority. The order types of the handled items, the criteria to filter, and to sort them can be freely configured. Filter and sorter may be defined independent from the ODL. Selection can be aborted after the number of necessary items is reached. The selection from the ODL may obey the corresponding sort profile.

The ODL may have a type which may define the nature of items that can be contained in the ODL. For example, the types “Obtain Confirmation (RCV)”, “Lose Confirmation (SPL)”, and “Free Work List (WLS)” are supported. The filter assigned to the ODL may comprise a filter type and a filter variant. The filter type may define the criteria and the variant may contain the values of the criteria to select the items. Several variants can be defined for each filter type. The sorter assigned to the ODL may contain the criteria for sorting the items. Database objects and source code may be generated out of the settings of an ODL. An ODL may comprise a database table with a specific database index and specific source code for table access. The generated database table may depend on the criteria that is used to calculate the item priority (sorter). The generated source code for selection from the ODL can be used, for example, by any SAP SCM application.

The ODLs of the type “Free Work List” may be defined without specifying a filter. The assignment of the sorter may be optional. They may be filled manually and can be used like a notepad for order items. Items can be added to this ODL in the display of the explanation component of the availability check, in the display of the backorder processing (BOP) result, or in the display of the worklist. The situations where items can be added to work list ODLs are not restricted. These work list ODLs can be used as a work list of BOP.

In conventional systems, the complete selection of affected items from several database tables and LiveCache was necessary. Sorting the items was only possible after filtering them from the database. No sort/filter based reference was available. In contrast, in accordance with embodiments of the present invention, it is possible to let the customizable filter work before storing the data in a reference table. Further, a quick item search by creating a customized database object is also possible. It is possible to allow creation of ODLs only if it is needed.

ODLs can be used at any place where pre-selected lists of orders or order items are necessary (e.g. out of performance reasons). ODLs can be used, for example, in SAP SCM during event driven quantity assignment (EDQA) and also in back order processing as a reference to items that should be confirmed, during reassignment of quantity confirmations (ROC) as a reference to items that can lose their confirmations and during backorder processing as a work list. Using ODLs, a list of items fulfilling the criteria of the filter may be selected. The ODL may provide an index in the database table, so that all data in the table can be accessed. For example, a sales order may be stored in LiveCache or 10 database tables where there are between 500 to 800 fields. ODLs may be linked to the databases where the order ID may be used as a key. Accessing the database using a key is fast, since the index may be used to pre-select very quickly. The index may be defined by customizing based on the sorter definition. In this way, the system finds all items associated with the order for BOP.

FIG. 2 shows an exemplary event driven quantity assignment, according to an embodiment of the present invention. In FIG. 2, the trigger event 1 is a goods receipt. In order to select the affected items an order due list may be used. The order due lists may be stored in stored data 4. In this way, the affected items may be selected and may undergo backorder processing in the BOP kernel 3. The confirmed backorders output may be provided as the results list 5. By customizing the event driven gATP (global ATP) services, it is seen that goods received may become invisible to a sales order 100 which may be incoming during a time in which the goods received are available to be assigned to the sales order. For such a sales order, the ATP check 16 may carry on as if the goods had not been received. Thus, by customizing the event driven gATP services, the priority with which the goods are assigned can be determined.

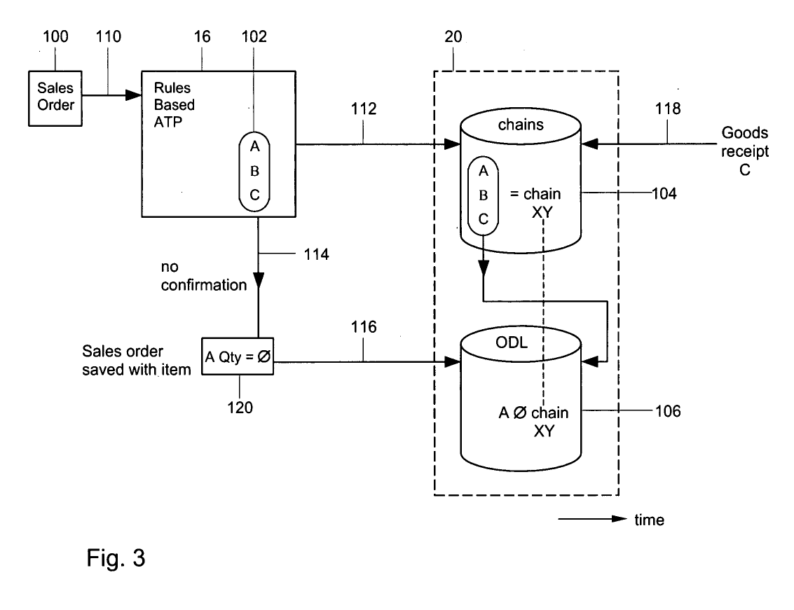

FIG. 3 describes in more detail the procedure when a sales order 100 is created or changed and the ensuing ATP check is executed, according to a further embodiment of the invention. If the system is unable to confirm an order, rules based ATP (RBA) may be carried out. A rules based availability check can be used to automatically or manually optimize the decision making process between alternatives using predefined rules. A sales order item may be confirmed on basis of RBA. After saving the sales order, its data from an OLTP system may be stored in live cache and several database tables in SAP SCM. In general and with respect to RBA, such an item can be replaced by another item with product/location that differs from the original. This replacement can be executed by means of backorder processing (BOP). A problem in conventional supply chain management systems is that it is not possible to determine the item that can possibly receive the quantity on replacing product/location, because it is necessary to evaluate RBA anew at the moment of selection. In conventional systems a quick search of affected items is not possible. In particular, in conventional systems, once a sales order is saved, a complete rules evaluation is necessary. Thus, the quality and speed of the availability check is compromised. In a sales order, RBA can cause the creation of a main item with several sub-items reflecting the alternatives on a product/location level. In RBA, additional criteria may be defined in order to determine the outcome if the order cannot be confirmed. For example, if a customer orders a yellow car, the rule may specify that he will be given a red car instead. Similarly, if the order cannot be confirmed from stock in a first manufacturing location, the rule may specify that the order is honored from stock in a second manufacturing location. In this way, global ATP may be provided to allow a switch between locations.

With further reference to the example of FIG. 3, a sales order 100 may be received (step 110). For example, it may be received from an OLTP system such as SAP CRM or ERP. The rules based ATP check 16 may carry out a rules based ATP evaluation. Rules based ATP (also referred to as global ATP) provides the opportunity to check alternatives when the sales order cannot be completely confirmed. It is highly flexible. RBA evaluation may include one or more location product substitution chains 102. Each chain may comprise a set of one or more rules. For example, chain ABC 102 includes substitutions (location products) A, B and C. Location product A may result from a rule that exchanges red phones with yellow phones if red is not available. Location product B may result from a rule that handles the case that there is a new product on the market and may be an instruction to first sell the old product; for example, if old product is out, send the new product. Location product C may result from a rule that arranges to check a second manufacturing location when a product is not available from a first manufacturing location. The chains 102 may be stored (step 112) in a separate database table 104. The chains 102 may be stored with an identifier. For example, in FIG. 3, the identifier for chain ABC is “XY”. The chain ID may also be assigned to corresponding items in an ODL 106. If during the RBA evaluation no confirmation is found for the sales order 100 (step 114), the sales order may be saved with item as “confirmed quantity of location product A is equal zero”. The non-confirmed sales order may be saved in ODL 106 together with the identified chain. When a goods receipt for location product C is received (step 118), the orders that can now be confirmed by the receipt of the goods may be selected using the data stored in the ODL 106. Thus, non-confirmed orders can be confirmed on receipt of goods without having to carry out the RBA evaluation at the selection again. In this way, the system can react on received goods without having to run RBA again. RBA chain identifiers may have application during event driven quantity assignment (EDQA) together with order due lists (ODL) and during backorder processing (at the selection and at the parallelization of BOP). FIG. 3 shows a system for carrying out an availability check according to an embodiment of the invention. During an ATP check, the chain of product/location substitutions (chain ABC 102) may be kept in a buffer, (e.g.: a buffer in an ATP buffer) in SAP SCM on order item level until the order is saved and updated in SAP SCM. During the update process in SAP SCM, the last valid substitution chain 102 may be saved in a separate database table 104. Each chain 102 has an ID “chain XY”. A new chain/new chain ID may be created only if there is no existing chain with the same product-location-combinations, while on the contrary, their sequence may differ. The chain ID “chain XY” may be used later as a connecting part by processes, where the determination of potential replacements of product-location-combinations in order items is necessary. In this way, the necessity of complete rules evaluation at the selection is avoided.

Order due lists are herein described in further detail with reference to the exemplary embodiments of FIGS. 4 and 5. Order due lists may be defined, generated, and activated using an ODL builder and ODL agent. Generation of corresponding database tables for storage in ODL 106 may be performed by the ODL builder may be based on customizable filter and sort parameters. The ODL builder may also generates selection source code, which may be used during the EDQA and filter source code that may be used for filling the index tables. The ODL builder may build a cross reference for items in accordance with a chain identifier to allow a fast access to the appropriate sales orders. Once the ODL is generated, the generated tables may be filled by an ODL agent, for example, in SAP APO. The data 120, for example, “Location product A with confirmed quantity equal zero”, to be filled in the generated tables may be prepared by the rules based ATP check 16 caused by order processing in the OLTP system, for example, a SAP CRM Order Management system. The data to be filled in the tables may be buffered in an ATP buffer prior to being filled in the tables in a ODL 106 by the ODL agent. The ATP rules evaluation may store the corresponding chain ABC 102 in a temporary data buffer, ATP buffer. The data may be stored in the ATP buffer until the document is saved. The ODL is a data base object that may comprise one or more tables. The tables may be generated by the ODL building according to sort profiles to allow fast data selection. The ODL builder may build the database tables of ODL in the SAP APO. The table structure may depend on the sort profile which is used during the selection of the orders. The sort profile may define the sequence in which the items are to be processed. The sort profile may specify the characteristics, their sequence (or weighting) and the sort direction.

FIG. 4 shows an activated ODL, according to an embodiment of the present invention. The ODL definition 30 may includes a predefined filter type 32 and filter variant 40, for example, a filter type: CHAIN XY with filter variant: NR_ONE. This may form a filter where the evaluation of the chain is enabled. All replacements of the chains containing the specified products may enhance the selection range of the product. The ODL definition 30 may also include a sort profile 34, for example, a sort profile: SORT 2. The filter type 32 and the sort profile 34 may be customizable. The ODL 30 may have an identifier 36 and a name 38. A filter variant 40 with filter conditions for a filter type can be created and used. As mentioned above, the filter may select items corresponding to the particular filter to the particular data base. For example, the filter type may define—parameter—customer type. The filter variant may define parameter value—customer type—very important or medium. The variant can be maintained by clicking on the “maintain variant” icon 41. The predefined sort profile 34 is chosen. In the example shown, the sort profile 34 is SORT2. Once the ODL is defined, the corresponding table can be generated by clicking on generate icon 42. A generated table can be activated by clicking on the activate icon 44. It can be activated and filled by data stored in a database-by clicking on the icon activate and fill 46. In the example shown, ODL definition 30 includes a status 48 which shows that the ODL is “activated”.

The ODL builder data basis may comprise the following object groups: structure for definition of fields valid for all filter types and sort profiles, database tables for filter definition and generation of corresponding program code statements, database tables for sort profile definition and generation of corresponding program code statements and database table for assigning of filter/sort to ODL tables and generation/activation of the tables.

The ODL definition further includes a filter variant definition according to an embodiment of the current invention. Having chosen a filter type 32, a filter variant 40 that is valid for the filter type can be chosen. The variant may be predefined, i.e. already created and maintained. Further, the filter variant can be maintained. It is also possible to create a filter variant. The filter variant may include the filter conditions according to the filter type parameters. The filter variant 40 and the filter type 32 may build together the actual filter 32, 40. Further, a sort profile 34 can be chosen from one of the predetermined, maintained sort profiles. Within the maintenance view screen it is also possible to change ODL description, delete ODLs, generate ODLs, drop and refresh code, activate ODLs 44, activate and fill tables 46, and deactivate ODLs. As mentioned, the filter type definition and the sort profile definition can be customized. Based on the sort profile 34, a database table with appropriate database index may be generated by clicking on the generate icon 42. Based on the chosen filter 32 and program code template, a program name 50, for example, XYZ, and program code for filling the table by the ODL agent 14 may be generated. Based on the chosen sort profile 34 and program code template, a program name 50 and program code for selection from the table by EDQA may be generated. Once generated, the status 48 of the ODL may become GENERATED 52. It is noted that the ODL table, although generated, does not contain any entries at this point. Activation of a table by clicking on the activate icon 44 may immediately enable filling it by necessary and eligible index data. The function activate and fill 46 can be used for filling the table with index data of possibly already existing backorder items, which may be eligible for the table. The table (filter/sort) can be valid for greater than or equal to 1 trigger events 1. Reassigning a filter/sort may make ODL organization necessary, for example, if it is decided to use a different filter but the existing data does not meet the conditions of reorganizing. Below the ODL definition 30, a screen shot shows an example of a filter variant. The filter parameters ‘product’ and ‘source location’ are chosen and can be maintained.

FIG. 5 is a screen shot illustrating an example of how the selection via a chain may be made visible in the system, according to an embodiment of the current invention. The indicator “consider substitutes” 130 and the button “add substitutions” 132 may both work at the chain. They work together with the range “product”. ”Multilevel ATP” 134 and “add components” 136 may work in the same way but using another source to get the list of products.

The function “Range” may be standard functionality in the user interface of SAP. It means that the user can for example add a list of product names and/or a range of all products between “A” and “CCCC” and/or a pattern of a product name, for example, all products whose name starts with “A”.

The user may have two possibilities to use the chain together with the selection via the product. The basis for this functionality is always the list of products specified in the range “product”. In the following it is referred to as “specified products”.

If the indicator “consider substitutes” 130 is set, automatically all other products related to the specified one may be added to the range of products in the filter. This enhancement of the filter range may be done at any execution of the filter. The list may be based on the current information in the replacement change, but it cannot be influenced by the user.

If instead, the button “add substitutions” 132 is pressed, the actual content of the replacement chain may be read and added to the range “product” that can be seen in the screen. This is done if the user defines the filter variant. The-range may contain the actual active situation and will not reflect automatically any changes done in the future in the rules. To get an update, the filter variant of the replacement may be changed. This can be done with minimal manual effort. If the range is enhanced by the content of the related replacement chains, the user can modify the list of products. He can add or delete entries out of the list.

It is to be noted that the above-mentioned embodiments illustrate rather than limit the invention, and that those skilled in the art will be able to design alternatives without departing from the scope of the appended claims. For example, the computational aspects described here can be implemented in digital electronic circuitry, or in computer hardware, firmware, software, or in combinations of them. Where appropriate, aspects of these systems and techniques can be implemented in a computer program product tangibly embodied in a machine-readable storage device for execution by a programmable processor, and method steps can be performed by a programmable processor executing a program of instructions to perform functions by operating on input data and generating output. The mere fact that certain measures are recited in mutually different claims does not indicate that a combination of these measures cannot be used to advantage.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for automatically assigning an incoming quantity of goods in response to an event, the system comprising:
an inbound interface for interfacing with a plurality of data storage devices, in at least one of which the incoming quantity of goods are stored as data and a plurality of sales orders to be confirmed are stored;
an execution memory operable to hold a software system; and
a processor for coupling to the inbound interface and the execution memory, the processor being operable to execute the software system such that the software system operates to select a subset of sales orders from the plurality of sales to be confirmed according to one or more predetermined criteria and to assign to the subset of sales orders the incoming quantity of goods.

2. The system of claim 1, wherein an order due list defines the predetermined criteria.

3. The system of claim 2, wherein the system operates to customize the order due list to select sales orders in accordance with a priority rating.

4. The system of claim 1, wherein the plurality of sales orders are backorders.

5. The system of claim 1, wherein a category of the incoming goods is changed so that the incoming goods are no longer considered in an availability check.

6. The system of claim 1, wherein the software system operates to immediately assign the incoming quantity of goods to the subset of sales orders.

7. A method of automatically assigning an incoming quantity of goods in response to an event, the method comprising:
interfacing with a plurality of data storage devices, in at least one of which the incoming quantity of goods are stored as data and a plurality of sales orders to be confirmed are stored;
holding a software system in an executable memory;
coupling the inbound interface to the execution memory; and
executing the software system such that the software system operates to select a subset of sales orders from the plurality of sales to be confirmed according to one or more predetermined criteria and to assign to the subset of sales orders the incoming quantity of goods.

8. The method of claim 7, wherein the step of executing further comprises using an order due list that defines the predetermined criteria.

9. The method of claim 8, wherein the step of executing further comprises customizing the order due list to select sales orders in accordance with a priority rating.

10. The method of claim 7, wherein the plurality of sales orders are backorders.

11. The method of claim 7, wherein the step of executing further comprises changing a category of the incoming goods so that the incoming goods are no longer considered in an availability check.

12. The method of claim 7, wherein the step of executing further comprises operating the software system to immediately assign the incoming quantity of goods to the subset of sales orders.

13. The method of claim 7, further comprising employing a user terminal.

14. A computer readable storage medium storing a program which when run on a computer directs the computer to perform a method comprising the following steps:
interfacing with a plurality of data storage devices in at least one of which the incoming quantity of goods are stored as data and a plurality of sales orders to be confirmed are stored;
holding a software system in an executable memory;
coupling the inbound interface to the execution memory; and
executing the software system such that the software system operates to select a subset of sales orders from the plurality of sales to be confirmed according to one or more predetermined criteria and to assign to the subset of sales orders the incoming quantity of goods.

15. The computer readable storage medium of claim 14, wherein the step of executing further comprises using an order due list that defines the predetermined criteria.

16. The computer readable storage medium of claim 15, wherein the step of executing further comprises operating to customize the order due list to select sales orders in accordance with a priority rating.

17. The computer readable storage medium of claim 14, wherein the plurality of sales orders are backorders.

18. The computer readable storage medium of claim 14, wherein the step of executing further comprises changing a category of the incoming goods so that the incoming goods are no longer considered in an availability check.

19. The computer readable storage medium of claim 14, wherein the step of executing further comprises operating the software system to immediately assign the incoming quantity of goods to the subset of sales orders.
